(19) United States
(12) Patent Application Publication
(10) Pub. No.: US 2004/0052299 A1
(43) Pub. Date: Mar. 18, 2004

(54) Temperature correction calibration system and method for optical controllers

(76) Inventors: Paul R. Jay, Stittsville (CA); Kenneth C. Mikolajek, Kanata (CA)

Correspondence Address: BORDEN LADNER GERVAIS LLP, WORLD EXCHANGE PLAZA, 100 QUEEN STREET SUITE 1100, OTTAWA, ON, K1P 1J9, CA

(21) Appl. No.: 10/243,763

(22) Filed: Sep. 16, 2002

(51) Int. Cl. G01K 15/00; G01K 7/00

(52) U.S. Cl. 374/183; 374/1

(57) ABSTRACT

Existing photodiodes in an optical component used for monitoring input light levels are used to measure the internal temperature of the optical component. Electrical measurements are taken across the photodiode while it is slightly forward biased, and the approximate temperature is determined according to pre-measured current-voltage characteristics of the optical component calibrated at different temperatures. By adjusting its parameters to compensate for the temperature, the performance of the optical component can be optimized. An external microprocessor system controls biasing of the photodiode, electrical measurement of the photodiode, and determination of the optical component temperature.

### FIELD OF THE INVENTION

The present invention relates generally to temperature measurement systems. More particularly, the present invention relates to temperature measurement of optical modules or components.

### BACKGROUND OF THE INVENTION

Optical functional devices are an essential component of optical systems. Signal loss and attenuation of signal strength are important considerations in designing an optical system whether that system serves a communications, computing, medical technology or some other function.

Fiber optic technology is well known and is used in a variety of communications networks. These networks often use long transmission lines that are subject to attenuation of the signal. To compensate for this reduced signal strength, optical functional devices, such as optical fiber amplifiers, are used to boost the signal, thereby allowing long-haul transmission.

Optical functional devices are formed of optical components, singly, or in combinations. These optical components include: erbium doped fiber amplifiers (EDFAs); Raman Amplifiers; semiconductor optical amplifiers (SOAs); erbium doped waveguide amplifiers (EDWAs); wideband optical amplifiers (WOAs); variable optical attenuators (VOAs); modulators; lasers; fiber lasers; laser arrays; micro-electrical mechanical systems (MEMS); tuneable lasers; optical switches; Dynamic Channel Equalizers; Differential Gain Equalizers; Optical Channel Monitors; Optical Performance Monitors; and tuneable filters.

Many of these components are sensitive to temperature, especially increased temperature due to ambient conditions and self-heating from power dissipation. In particular, the performance of the optical functional device can change or degrade as the temperature increases. For example, the gain of a fiber amplifier can decrease at high temperatures to reduce the overall efficiency of the network. Further details regarding the temperature dependence of doped fiber amplifiers is presented in the paper titled “Model of Temperature Dependence for Gain Shape of Erbium-Doped Fiber Amplifier” by Bolshtyansky et al. published in the Journal of Lightwave Technology, Vol. 18, No. 11 in November 2000. Other component parameters such as noise can also be affected by temperature. A common well-known solution to this problem is to provide a thermoelectric cooler that reduces the temperature, or at least maintains a constant temperature of the component, thus returning its operation to an optimum status. Typically, a means for measuring the temperature of the component is required for turning the thermoelectric cooler on and off in accordance with predefined temperature thresholds. Preferably, the sensor for measuring temperature is located within the component to obtain the most accurate measurement. Some optical functional devices use temperature as a means to control optical functional component parameters, such as laser wavelength for example. Hence knowing the temperature of the optical functional device permits more accurate control over the operation of the device.

The addition of a thermoelectric cooler, or heater, may not be feasible as it will consume significant amounts of power and increase the form factor of the optical functional device. Disassembly of the optical functional device may be required for installation of a temperature sensor, which is labour intensive and can potentially lead to inadvertent damage to the device. Hence the cost of the thermoelectric cooler/heater, and temperature measurement apparatus in addition to the power consumption cost, and associated costs for device modification may not offset the cost for operating a system without temperature correction. In other words, the reduced efficiency of the system is accepted despite the available solutions to correct the problem.

It is, therefore, desirable to provide a cost effective system for maintaining optimal performance of an optical component in accordance with the internal temperature of the component.

### SUMMARY OF THE INVENTION

It is an object of the present invention to obviate or mitigate at least one disadvantage of previous optical functional device temperature measurement systems. In particular, it is an object of the present invention to provide a system that uses an existing photodiode of the optical functional device to determine the temperature of the optical functional device based upon temperature calibrated I-V data of the photodiode.

In a first aspect, the present invention provides a controller for determining a temperature of an optical functional device based on temperature calibrated current-voltage characteristics of the optical functional device. The optical functional device has a photodiode, and the controller includes a source, a measurement circuit, an analog to digital circuit, and a microprocessor. The source forward biases the photodiode, the measurement circuit measures an electrical parameter of the forward biased photodiode, the analog to digital circuit converts the measured electrical parameter into a digital signal, and the microprocessor calculates the temperature corresponding to the digital signal in accordance with the temperature calibrated current-voltage characteristics.

In an alternate embodiment of the present aspect, the source includes a constant current source and the measurement circuit includes a voltage amplifier for measuring the voltage across the forward biased photodiode.

In a further aspect of the present embodiment, the controller includes a constant voltage source for reverse biasing the photodiode in a photodetection operation, a current to voltage converter for measuring the current of the reverse biased photodiode, and biasing means for setting the photodiode under reverse bias conditions for photodetection and under forward bias conditions for temperature detection.

In yet another aspect of the present embodiment, the switching selectively couples the constant voltage source to the photodiode and the current to voltage converter to the analog to digital circuit in a first state for measuring the optical power of the optical functional device. Furthermore, the switching means selectively couples the constant current source to the photodiode and the voltage amplifier to the analog to digital circuit in a second state for determining the temperature of the optical functional device.

In another embodiment of the present aspect, the microprocessor includes embedded memory for storing the temperature calibrated current-voltage characteristics, and provides control data for optimizing the performance of the optical functional device for the temperature.

In another embodiment of the present aspect, the source includes a constant voltage source and the measurement circuit includes a current to voltage converter for measuring the current of the forward biased photodiode.

In a second aspect, the present invention provides a method for determining a temperature of an optical functional device based upon temperature calibrated current-voltage characteristics of the optical functional device, the optical functional device having a photodiode for measuring optical power. The method including the steps of forward biasing the photodiode, measuring an electrical parameter of the forward biased photodiode, and calculating the temperature corresponding to the measured electrical parameter in accordance with the temperature calibrated current-voltage characteristics.

In a preferred embodiment of the present aspect, the photodiode is forward biased at voltages less than about 0.5 volts.

In an alternate embodiment of the present aspect, the photodiode is forward biased with a constant current source, the measured electrical parameter of the forward biased photodiode is voltage, and the step of measuring further includes converting the voltage measurement into a digital signal.

In yet another alternate embodiment of the present aspect, the photodiode is forward biased with a constant voltage source (less than about 0.5V), the measured electrical parameter of the forward biased photodiode is current, the step of measuring further includes converting the current measurement into a voltage measurement, and the step of measuring further includes converting the voltage measurement into a digital signal.

In a further embodiment of the present aspect, the temperature calibrated current-voltage characteristics of the optical functional device are determined by inserting the functional optical device into a temperature chamber, setting calibration temperatures for the temperature chamber, setting calibration electrical parameter values, measuring the photodiode forward bias response to the electrical parameter values for each calibration temperature, and storing the measured photodiode forward bias response and corresponding electrical parameter values for each calibration temperature in the controller.

In alternate aspects of the present embodiment, the calibration electrical parameter values include current and the photodiode forward bias response include voltage, or the calibration electrical parameter values include voltage and the photodiode forward bias response include current.

In a third aspect, the present invention provides method for performance optimization of an optical functional device based upon temperature calibrated current-voltage characteristics of the optical functional device, the optical functional device having a photodiode for measuring optical power. The method includes the steps of forward biasing the photodiode, measuring an electrical parameter of the forward biased photodiode, calculating a temperature corresponding to the measured electrical parameter in accordance with the temperature calibrated current-voltage characteristics, and providing control data for optimizing performance of the optical functional device to compensate for the calculated temperature.

Other aspects and features of the present invention will become apparent to those ordinarily skilled in the art upon review of the following description of specific embodiments of the invention in conjunction with the accompanying figures.

### BRIEF DESCRIPTION OF THE DRAWINGS

Embodiments of the present invention will now be described, by way of example only, with reference to the attached Figures, wherein:

FIG. 1 is a block diagram of an optical function system according to an embodiment of the present invention.

FIG. 2 is a block diagram of an optical power measurement system for an optical component;

FIG. 3 is a block diagram of a temperature measurement system for the optical component of FIG. 2 according to an embodiment of the present invention;

FIG. 4 is a block diagram of a combined optical power and temperature measurement system according to an embodiment of the present invention;

FIG. 5 is a flow chart illustrating a temperature calibration sequence for an optical component according to another embodiment of the present invention; and,

FIG. 6 is a plot of current-voltage curves obtained through the calibration procedure shown in FIG. 5.

### DETAILED DESCRIPTION

Existing photodiodes in an optical component used for monitoring input light levels are used to measure the internal temperature of the optical component. Electrical measurements are taken across the photodiode while it is forward biased, and the approximate temperature is determined according to pre-determined I-V characteristics of the optical component calibrated at different temperatures. By adjusting its parameters to compensate for the temperature, the performance of the optical component can be optimized. An external microprocessor system controls biasing of the photodiode, electrical measurement of the photodiode, and determination of the optical component temperature. The I-V characteristics of the optical component can be stored in a look-up table or as curve-fitted functions for the microprocessor to determine the temperature from a voltage measurement of the PIN diode. Built-in algorithms can also be used to correct the response relationships for aging effects.

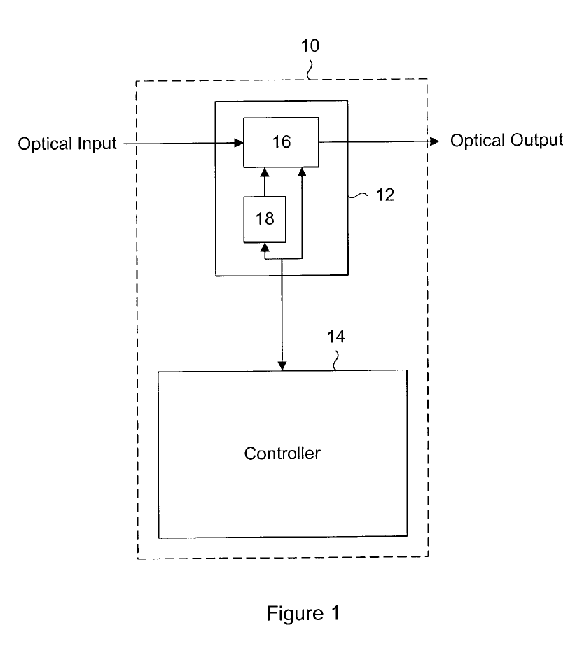

FIG. 1 illustrates an embodiment of the present invention showing an optical function system 10. The present schematic is a simplified representation to provide an overview of the system.

Optical function system 10 includes an optical function subsystem 12 coupled to a controller 14. The optical function subsystem 12 includes an optical functional device such as an optical fiber amplifier 16 and a laser pump 18. Optical fiber amplifier 16 receives an optical input and provides an optical output having a gain determined by laser pump 18. The controller 14 receives data from the optical fiber amplifier 16, and then determines the appropriate laser pump current needed to excite the rare earth atoms within the fiber to induce light emission, thereby amplifying the optical input signal. The controller 14 includes a programmable microprocessor that executes algorithms, and additional functional components for processing the data from the optical fiber amplifier 16. Controller 14 can also include an interface for communication of information to the external network and for enabling user input. These additional functional components of controller 14 are described later in further detail.

Many optical components include at least one photodiode, or more specifically, p-type/intrinsic/n-type (PIN) photodiodes for monitoring, or measuring, input light levels from a fiber optic cable. For example, optical fiber amplifier 16 of FIG. 1 includes a PIN photodiode, and many lasers are assembled with a back-facet monitor PIN diode in close proximity to the laser chip.

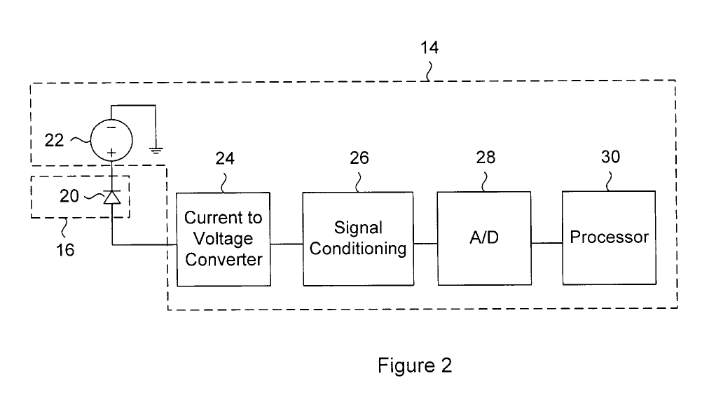

FIG. 2 is a block diagram showing the functional components of controller 14 from FIG. 1 that are required for performing optical power measurements from a PIN photodiode 20 in optical fiber amplifier 16. Those of skill in the art will understand that only the components of controller 14 and optical fiber amplifier 16 that are necessary for performing the optical power measurement are shown to simplify the schematic. As previously mentioned, PIN photodiode 20 is located within optical fiber amplifier 16, and controller 14 includes a voltage source 22, current to voltage converter 24, a signal conditioning block 26, an analog to digital (A/D) converter 28, and a microprocessor 30. In a photodetection mode for measuring input light, a stable voltage from voltage source 22 is applied to the reverse biassed PIN photodiode 20. PIN photodiode 20 generates a current that is proportional to the light intensity inside optical fiber amplifier 16, which is converted to a voltage level by current to voltage converter 24. The voltage converter 24 can be substituted with a transimpedance amplifier or a logarithmic amplifier, for example. The resulting voltage level is fed to AID converter 28 for generating a corresponding digital signal. Optionally, the voltage level from current to voltage converter 24 can undergo conditioning through signal conditioning block 26 to adjust voltage ranges to comply with A/D requirements and to reduce electrical noise. Now that the current from PIN photodiode 20 is represented as a digital signal, microprocessor 30 can provide a usable optical power measurement. It should be apparent to those of skill in the art that the optical power measurement algorithm is well known, and can be programmed into microprocessor 30 for execution.

As previously mentioned, optical power measurements can be taken by reverse biasing the PIN diode in the presence of light. According to an embodiment of the present invention, the PIN diode 20 of the optical fiber amplifier is slightly forward biased for determining its temperature, and as a result an estimate of the internal temperature of the optical fiber amplifier and its associated components, such as optical taps for example. Typically, the diode is forward biased at voltages less than 0.5 volts, or its threshold voltage, which does not require large amounts of current that can potentially damage components of the optical functional device. PIN diodes have a voltage-temperature relationship where the voltage measured across the terminals increases as the temperature increases during forward bias operation. Furthermore the current of a PIN diode is expressed by the general function I=constant x exp(qV/nkT), where “constant” and “n” are both inherent characteristics of a given diode, and can therefore be determined at calibration. As is obvious to those skilled in the art, k is Boltzmann's constant, and q is the charge on an electron, both quantities for which the values are well-documented. It follows that once the I-V electrical characteristics of the PIN diode are known for varying temperatures, a simple measurement of the PIN diode electrical parameters, such as current or voltage during forward bias operation, permits an approximation of the temperature of the PIN diode. Performance of the optical component can then be optimized for the approximated temperature. In reverse bias any carriers created by light falling on the PIN diode appear as a small photocurrent, however in forward bias this photocurrent is relatively small, and contributes only a small linear displacement on the current axis. Hence its effect will not impact the gradient of the I-V characteristic used to determine the temperature.

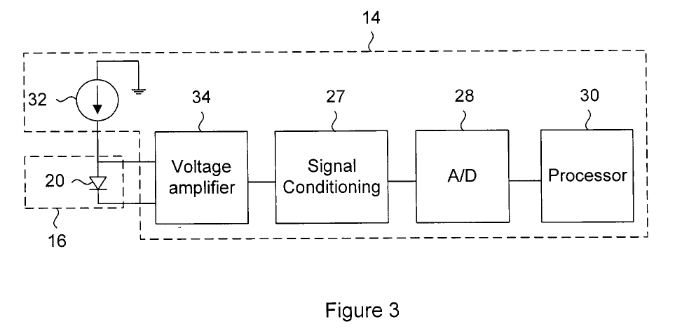

FIG. 3 is a block diagram showing the functional components of controller 14 from FIG. 1 that are required for performing temperature measurements from a PIN photodiode 20 in optical fiber amplifier 16 according to an embodiment of the present invention. Those of skill in the art will understand that only the components of controller 14 and optical fiber amplifier 16 that are necessary for performing the temperature measurement are shown to simplify the schematic. Many of the functional blocks of FIG. 3 are the same as those same numbered blocks in FIG. 2, such as A/D converter 28 and microprocessor 30. Signal conditioning block 27 performs the same function as signal conditioning block 26 of FIG. 2, but has been reconfigured to accommodate minor differences between voltage and current sensing operations, which would be obvious to those skilled in the art. In FIG. 3, a source such as constant current source 32 is connected to PIN diode 20 of the optical fiber amplifier 16 instead of voltage source 22, and current to voltage converter 24 is replaced by a measurement circuit such as voltage amplifier 34. To measure the temperature of PIN diode 20, constant current source 32 forward biases PIN diode 20 by supplying a constant current. Voltage amplifier 34 then measures the voltage across the terminals of PIN diode 20 and provides the measured voltage to A/D converter 28 via signal conditioning block 26. Signal conditioning block 26 and A/D converter 28 perform the same function as described above for FIG. 2. Microprocessor 30 then receives the digital representation of the measured voltage and determines the approximate temperature of PIN diode 20 based on the calibrated I-V characteristics of PIN diode 20. This temperature information is then used to optimize performance of the optical fiber amplifier 16 by adjusting the current supplied to laser pump 18 of FIG. 1 for example. It will apparent to those skilled in the art that the pulses used for the temperature measurement should be as short as possible to minimise heating caused by the measurement current.

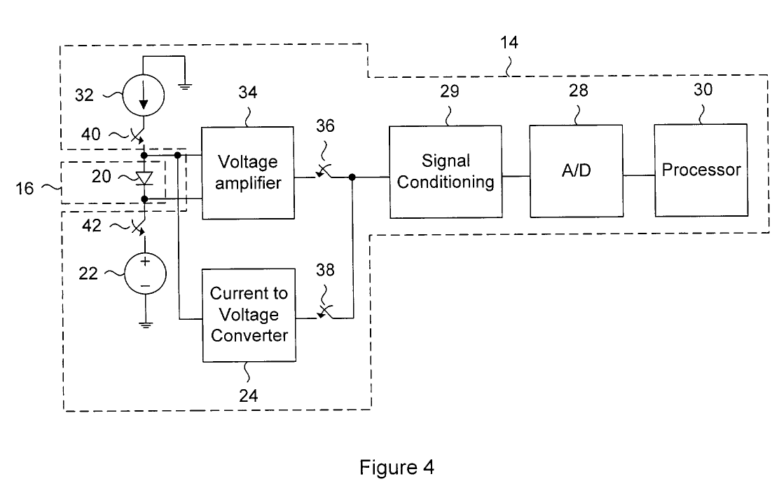

Although the optical power measurement system of FIG. 2 and the temperature measurement system of FIG. 3 are shown as distinct systems, both systems can be combined according to a further embodiment of the present invention as shown in FIG. 4.

FIG. 4 shows a block diagram of a combined optical power and temperature measurement system according to a further embodiment of the present invention. The combined system includes all the aforementioned components from FIGS. 2 and 3, and further includes switching means for setting the system into either the optical power measurement mode or the temperature measurement mode. The arrangement of A/D converter 28, and microprocessor 30 remain unchanged from FIGS. 2 and 3. Signal conditioning block 29 performs the same functions as blocks 26 and 27 from FIGS. 2 and 3 respectively, and can be switched internally to accommodate the different measurement modes. Current to voltage converter 24 and voltage amplifier 34 are in parallel with each other for providing their respective voltage measurements to signal conditioning block 26. The inputs of current to voltage converter 24 and voltage amplifier 34 are connected to the appropriate terminals of PIN diode 20 for measuring its current and voltage respectively. Voltage source 22 and constant current source 32 provide constant voltage and current respectively, to the appropriate terminals of PIN diode 20. The switching means is illustrated as switches 36, 38, 40 and 42. Switches 36 and 38 are complementary switches, as are switches 40 and 42. In other words, when switch 36 or 40 is closed, then switches 38 and 42 are open. The operating modes of the combined system of FIG. 3 can be changed by closing switch pairs 36/40 or 38/42. If switch pair 38/42 is closed, then the system is effectively configured as shown in FIG. 2 for measuring optical power. Otherwise, if switch pair 36/40 is closed, then the system is effectively configured as shown in FIG. 3 for measuring temperature. Various methods for implementing the switching means for providing the mode switching functionality will be known to those of skill in the art, thus further, description of their implementation is not required. The switching means, current source 32, voltage source 22, voltage amplifier 34 and current to voltage converter 24 can be controlled by microprocessor 30 according to its programmed algorithms to ensure proper operation of the combined system. For example, invalid switch combinations that can damage the system are prevented. Since optical power and temperature measurements cannot be taken concurrently, the mode change and voltage/temperature measurement of the PIN diode is preferably quick. This can be achieved through the use of standard components, such as high speed converters for example. A further reduction in measurement conflicts can be achieved by increasing the period between temperature measurements.

In an alternate embodiment of FIG. 4, the temperature of PIN diode 20 can be determined by forward biasing the PIN diode 20 with a constant voltage source instead of the constant current source 32. This particular embodiment can be realized by removing current source 32 and voltage amplifier 34. Voltage source 22 can be controlled by a biasing means to place PIN diode 20 under reverse bias conditions for photodetection operation and to place PIN diode 20 under forward bias conditions for temperature measurement operation. Such biasing means are well known in the art, and can involve the use of switches for changing the polarity of the voltage source, or for connecting a second voltage source to PIN diode 20. Correspondingly, switches 36, 38, 40 and 42 are not required in the presently described alternate embodiment of FIG. 4, and the resulting block diagram would resemble the one shown in FIG. 2. In the present alternate embodiment, the PIN diode 20 is forward biased by voltage source 22 and the resulting current is measured by current to voltage converter 24. Although this method is less accurate than measuring the diode voltage from a current source, the amount of error is small since the value of the currents is also small, and is negligible in many cases. The main advantage is the reduction in hardware components and logic for controlling the switching means over the system of FIG. 4.

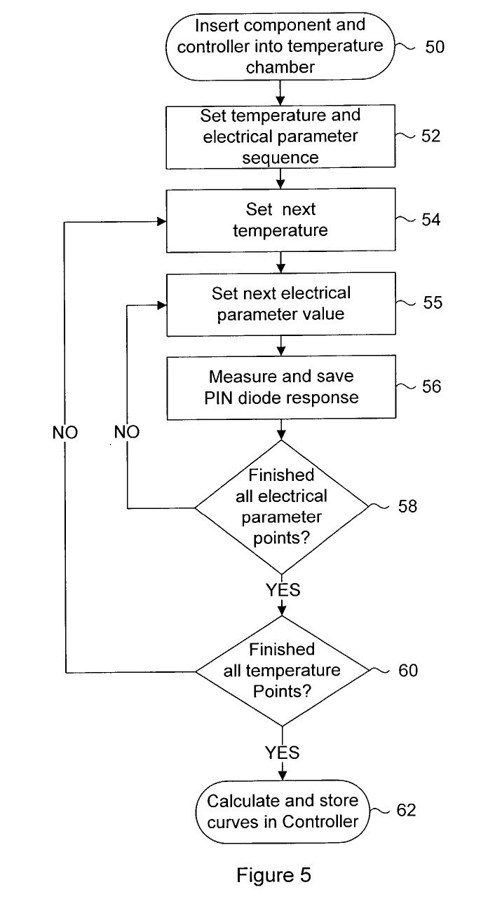

The PIN diode of the optical fiber amplifier can be calibrated by different methods known to those of skill in the art. As previously mentioned the purpose of calibrating an optical functional device such as an optical fiber amplifier, and more specifically the PIN diode within the optical functional device, is to obtain I-V characteristics of the PIN diode for different temperatures. Once the coefficients of the PIN diode current function I=constant×exp(qV/nkT) are obtained for the different temperatures, then measured forward bias voltage can be used to approximate the temperature. For example, “constant” relates to the geometry and doping of the diode, and by measuring dI/dV for different temperature values eliminates “n” and gives the corresponding temperature relationship. In the above current function, I is current, V is voltage, T is temperature and q and k are known constants. A presently preferred method of calibration is shown in the flow chart of FIG. 5.

The calibration method of FIG. 5 can be executed during manufacture of the optical component or the PIN diodes, or preferably after purchase of the optical functional device and prior to its installation within the network or system. Ideally the last stage of making the optical function device involves mating it to the controller and doing the calibrations automatically, with the numbers being stored in the controller, which then stays mated to the optical function for life. In accordance with a preferred embodiment of the present invention, the calibration procedure can be executed by the microprocessor 30 of FIG. 4 since the controller 14 already includes the necessary components for performing voltage measurements. The sequence starts at step 50 where the optical function system, optical function subsystem or optical functional device is inserted into a temperature control chamber. At step 52 the desired temperatures and electrical parameter values for which I-V characteristics are required are set in the test sequence. In the present example, the temperatures of interest are at 0, 25 and 70 degrees Celsius and the electrical parameter values can be voltage or current. The calibration temperature is set in step 54 for adjusting the temperature of the control chamber, and the calibration electrical parameter value is set in step 55 for forward biasing the PIN diode of the optical function system. In step 56 the forward bias electrical response of the PIN diode to the electrical parameter value set in step 55 is measured and saved. If the PIN diode is forward biased with a current source, then the corresponding response of the PIN diode would be a voltage. Alternatively, if the PIN diode is forward biased with a voltage source, then the corresponding response of the PIN diode would be a current. A decision is made in step 58 to determine if there are more electrical parameter values to calibrate. The process loops back to step 55 where a new electrical parameter value is set if further electrical parameter values remain for calibration at the current temperature setting. Otherwise, the process proceeds to step 60 where a decision is made to determine if there is another temperature point to calibrate. The method loops back to step 54 to set the next temperature point if there are further temperatures to calibrate. Otherwise, the method proceeds to step 62 where the I-V curve is calculated and stored in memory. The present example uses three calibration temperatures, however any number of calibration temperatures can be used with varying step sizes and with different minimum and maximum temperatures. Naturally, the calibration currents can be selected to optimise accuracy and calibration time. Microprocessor 30 of FIG. 4 can perform the necessary computations to interpolate I-V curves for temperature points that were not measured, or alternatively microprocessor 30 can perform calculations to determine a temperature corresponding to the measured voltage from the forward biased PIN diode. Such a calculation can involve solving the previously mentioned current function for temperature T. The measured calibration data for the PIN diode can be stored in the memory of the microprocessor 30, or stored in discrete memory accessible by the microprocessor 30. Once the temperature of the optical fiber amplifier 16 is determined, other functional components of controller 14 (not shown) can control the laser pump 18 or the optical fiber amplifier directly through control data, to adjust performance to compensate for the temperature. It will be apparent to those familiar with the art that control loops must be structured so as to avoid thermal hysteresis or effects that might give rise to temperature oscillations.

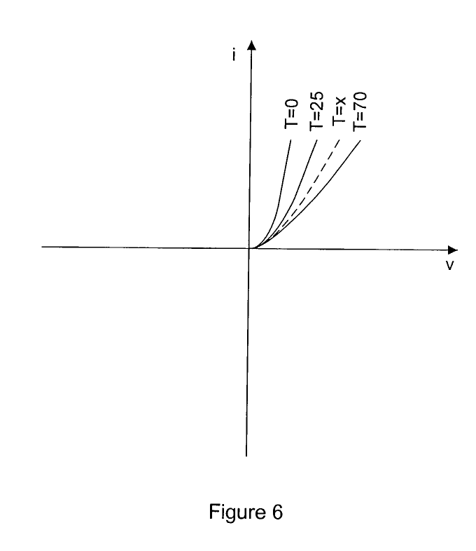

An example plot of the I-V curves for a PIN diode after the calibration procedure of FIG. 5 are shown in FIG. 6. In this example, the PIN diode has been calibrated at 0, 25 and 70 degrees Celsius, where each temperature at which the PIN diode has been calibrated is represented by a correspondingly labelled curve. The I-V plot of FIG. 6 illustrates temperature effect upon PIN diodes, where different temperatures change the slope of the I-V curve for the PIN diode. Therefore the forward biased PIN diode 20 can have I-V characteristics represented by the dashed I-V curve for a given temperature in FIG. 6. In the temperature measurement mode of the combined system of FIG. 4, microprocessor 30 can then perform calculations or use the temperature calibrated data stored in a look-up table to determine that the temperature of the PIN diode is approximately “x” degrees Celsius.

The embodiments of the present invention have been described in combination with PIN diodes of optical functional devices such as fiber amplifiers. The embodiments of the present invention can also be used in combination with lasers having back-facet monitor PIN diodes, and virtually any optical functional device having a PIN diode or equivalent optical diode. Examples of other optical functional devices include pump lasers, splitters and gratings. InP gratings used to split optical signals would benefit from the embodiments of the present invention because they need to be set to a known constant temperature for proper operation. The present invention permits the temperature of such a grating to be easily monitored for automatic compensation according to programmed algorithms.

In situations where component aging is a concern (whether aging of the PIN detectors or of the laser sources used) it is possible to combine the stored data with algorithms representing aging behaviour for that type of device, to determine whether any performance or response degradation is as-expected or may be drifting out of specification. For example, the temperature measurement system of the present invention can also be used to detect laser aging. By measuring the laser temperature, the laser can be rebiased for continued operation at lower power for a longer period of time before total failure, or until a replacement can be installed.

For an EDFA context with two power monitor PIN diodes and a back facet monitor PIN, there is an opportunity to cross-correlate the three potential temperature sensors against each other. Under certain circumstances, those skilled in the art will appreciate that some measure of in-field recalibration is also possible.

In another application, the measured temperature can be used to accurately tune array waveguide demuxes where the temperature governs the match of wavelengths to the ITU grid spacing. The microprocessor described in the figures can be a commercially available microprocessor or controller having embedded memory, or a custom application specific integrated circuit having embedded memory. Alternatively, the microprocessor can have access to external memory if the embedded memory capacity is insufficient.

The previously described embodiments of the present invention discuss the use of PIN diodes, however the previously described apparatus and method for calibration and temperature measurement of an optical functional system can also be applied to avalanche photodiodes (APD) or other devices that have a straightforward temperature dependence.

Therefore, the temperature within an optical component can be monitored and the performance of the optical functional device can be optimized on-the-fly without costly modifications to the optical component. Increased operating expenses can be avoided by eliminating the need for separate thermistors, and in some eases, thermoelectric coolers. Furthermore, temperature-dependent functions of optical functional devices can be compensated based on calibrated reference data. The inclusion of the additional temperature measurement functionality into existing controllers is a cost effective method for achieving optimum performance of the optical functional device.

The above-described embodiments of the present invention are intended to be examples only. Alterations, modifications and variations may be effected to the particular embodiments by those of skill in the art without departing from the scope of the invention, which is defined solely by the claims appended hereto.

What is claimed is:

1. A controller for determining a temperature of an optical functional device based on temperature calibrated current-voltage characteristics of the optical functional device, the optical functional device having a photodiode, the controller comprising:
a source for forward biasing the photodiode;
a measurement circuit for measuring an electrical parameter of the forward biased photodiode;
an analog to digital circuit for converting the measured electrical parameter into a digital signal; and,
a microprocessor for calculating the temperature corresponding to the digital signal in accordance with the temperature calibrated current-voltage characteristics.

2. The controller of claim 1, wherein the source includes a constant current source.

3. The controller of claim 2, wherein the measurement circuit includes a voltage amplifier for measuring the voltage across the forward biased photodiode.

4. The controller of claim 1, wherein the source includes a constant voltage source.

5. The controller of claim 4, wherein the measurement circuit includes a current to voltage converter for measuring the current of the forward biased photodiode.

6. The controller of claim 3, further including
a constant voltage source for reverse biasing the photodiode in a photodetection operation, and
a current to voltage converter for measuring the current of the reverse biased photodiode.

7. The controller of claim 6, wherein biasing means sets the photodiode under reverse bias conditions for photodetection and under forward bias conditions for temperature detection.

8. The controller of claim 6, wherein switching means selectively couple the constant voltage source to the photodiode and the current to voltage converter to the analog to digital circuit in a first state for measuring the optical power of the optical functional device.

9. The controller of claim 8, wherein switching means selectively couple the constant current source to the photodiode and the voltage amplifier to the analog to digital circuit in a second state for determining the temperature of the optical functional device.

10. The controller of claim 1, wherein the microprocessor includes embedded memory for storing the temperature calibrated current-voltage characteristics.

11. The controller of claim 1, wherein the microprocessor provides control data for optimizing the performance of the optical functional device for the temperature.

12. A method for determining a temperature of an optical functional device based upon temperature calibrated current-voltage characteristics of the optical functional device, the optical functional device having a photodiode for measuring optical power, the method comprising:
a) forward biasing the photodiode;
b) measuring an electrical parameter of the forward biased photodiode; and,
c) calculating the temperature corresponding to the measured electrical parameter in accordance with the temperature calibrated current-voltage characteristics.

13. The method of claim 12, wherein the photodiode is forward biased at voltages less than about 0.5 volts.

14. The method of claim 12, wherein the photodiode is forward biased with a constant current source.

15. The method of claim 14, wherein the measured electrical parameter of the forward biased photodiode is voltage.

16. The method of claim 15, wherein the step of measuring further includes converting the voltage measurement into a digital signal.

17. The method of claim 12, wherein the photodiode is forward biased with a constant voltage source.

18. The method of claim 17, wherein the measured electrical parameter of the forward biased photodiode is current.

19. The method of claim 18, wherein the step of measuring further includes converting the current measurement into a voltage measurement.

20. The method of claim 19, wherein the step of measuring further includes converting the voltage measurement into a digital signal.

21. The method of claim 12, wherein the temperature calibrated current-voltage characteristics of the optical functional device are determined by
i) inserting the functional optical device into a temperature chamber,
ii) setting calibration temperatures for the temperature chamber,
iii) setting calibration electrical parameter values,
iv) measuring the photodiode forward bias response to the electrical parameter values for each calibration temperature, and
v) storing the measured photodiode forward bias response and corresponding electrical parameter values for each calibration temperature in the controller.

22. The method of claim 21, wherein the calibration electrical parameter values include current and the photodiode forward bias response include voltage.

23. The method of claim 21, wherein the calibration electrical parameter values include voltage and the photodiode forward bias response include current.

24. A method for performance optimization of an optical functional device based upon temperature calibrated current-voltage characteristics of the optical functional device, the optical functional device having a photodiode for measuring optical power, the method comprising:
a) forward biasing the photodiode;
b) measuring an electrical parameter of the forward biased photodiode;
c) calculating a temperature corresponding to the measured electrical parameter in accordance with the temperature calibrated current-voltage characteristics; and,
d) providing control data for optimizing performance of the optical functional device to compensate for the calculated temperature.
